(19) United States
(12) Patent Application Publication
(10) Pub. No.: US 2024/0362072 A1
(43) Pub. Date: Oct. 31, 2024

(54) SYSTEMS, APPARATUSES, METHODS, AND COMPUTER PROGRAM PRODUCTS FOR MONITORING WORKFLOWS BASED ON STATUS TRIGGERS

(71) Applicant: HONEYWELL INTERNATIONAL INC., Charlotte, NC (US)

(72) Inventors: Ankit SINGH, Apex, NC (US); Timothy SNEED, Beachwood, NJ (US); Lakshminarayana PAILA, Knoxville, TN (US)

(21) Appl. No.: 18/308,345

(22) Filed: Apr. 27, 2023

(51) Int. Cl. G06F 9/50

(52) U.S. Cl. CPC G06F 9/5038

(57) ABSTRACT

Systems, apparatuses, methods, and computer program products are provided. For example, a method provided herein may include generating a configuration specification. In some embodiments, the configuration specification is associated with a plurality of computing instances. In some embodiments, the method may include receiving a status trigger from one of the plurality of computing instances. In some embodiments, the method may include parsing the configuration specification to determine that the status trigger was received from a first computing instance of the plurality of computing instances. In some embodiments, the method may include parsing the configuration specification to determine a first interface component of a plurality of interface components associated with the plurality of status trigger. In some embodiments, the method may include causing a user interface to be displayed, the user interface comprising the plurality of interface components.

### TECHNOLOGICAL FIELD

Embodiments of the present disclosure relate generally to monitoring workflows based on status triggers.

### BACKGROUND

Applicant has identified many technical challenges and difficulties associated with monitoring workflows based on status triggers. Through applied effort, ingenuity, and innovation, Applicant has solved problems related to monitoring workflows based on status triggers by developing solutions embodied in the present disclosure, which are described in detail below.

### BRIEF SUMMARY

Various embodiments described herein relate to monitoring workflows based on status triggers.

In accordance with one aspect of the disclosure, a computer-implemented method is provided. In some embodiments, the computer-implemented method may include generating a configuration specification. In some embodiments, the configuration specification is associated with a plurality of computing instances. In some embodiments, the computer-implemented method may include receiving a status trigger from one of the plurality of computing instances. In some embodiments, the status trigger is one of a plurality of status triggers. In some embodiments, the computer-implemented method may include parsing the configuration specification to determine that the status trigger was received from a first computing instance of the plurality of computing instances. In some embodiments, the computer-implemented method may include parsing the configuration specification to determine a first interface component of a plurality of interface components associated with the plurality of status trigger. In some embodiments, the first interface component is associated with the status trigger. In some embodiments, the computer-implemented method may include causing a user interface to be displayed, the user interface comprising the plurality of interface components. In some embodiments, the computer-implemented method may include causing the first interface component of the plurality of interface components to be updated based at least in part on the status trigger.

In some embodiments, the plurality of interface components are arranged on the user interface in a first interface configuration of a plurality of interface configurations.

In some embodiments, the first interface configuration is based at least in part on a user type.

In some embodiments, the first interface configuration is based at least in part on the first computing instance.

In some embodiments, the plurality of computing instances comprises at least one of a reconditioning computing instance, an import computing instance, a product quality review computing instance, a group print computing instance, an insights computing instance, a machine learning computing instance, or a fabric computing instance.

In some embodiments, the plurality of status triggers comprises at least one of a restart status trigger, a memory status trigger, a processing power status trigger, a workflow request status trigger, a workflow success status trigger, a workflow failure status trigger, or a workflow time status trigger.

In some embodiments, the plurality of interface components comprises at least one of a restart interface component, a memory interface component, a processing power interface component, a workflow request interface component, a workflow success interface component, a workflow failure interface component, or a workflow time interface component.

In some embodiments, the computer-implemented method may include determining that the first computing instance of the plurality of computing instances has been updated.

In some embodiments, the computer-implemented method may include generating an updated configuration specification based at least in part on the determination that the first computing instance has been updated.

In some embodiments, the first interface component is updated in real-time.

In some embodiments, the configuration specification identifies one or more workflows performed by the first computing instance of the plurality of computing instances.

In accordance with another aspect of the disclosure, an apparatus is provided. In some embodiments, the apparatus may include at least one processor and at least one memory coupled to the at least one processor. In some embodiments, the at least one processor is configured to generate a configuration specification. In some embodiments, the configuration specification is associated with a plurality of computing instances. In some embodiments, the at least one processor is configured to receive a status trigger from one of the plurality of computing instances. In some embodiments, the status trigger is one of a plurality of status triggers. In some embodiments, the at least one processor is configured to parse the configuration specification to determine that the status trigger was received from a first computing instance of the plurality of computing instances. In some embodiments, the at least one processor is configured to parse the configuration specification to determine a first interface component of a plurality of interface components associated with the plurality of status trigger. In some embodiments, the first interface component is associated with the status trigger. In some embodiments, the at least one processor is configured to cause a user interface to be displayed, the user interface comprising the plurality of interface components. In some embodiments, the at least one processor is configured to cause the first interface component of the plurality of interface components to be updated based at least in part on the status trigger.

In some embodiments, the plurality of interface components are arranged on the user interface in a first interface configuration of a plurality of interface configurations.

In some embodiments, the first interface configuration is based at least in part on a user type.

In some embodiments, the first interface configuration is based at least in part on the first computing instance.

In some embodiments, the plurality of computing instances comprises at least one of a reconditioning computing instance, an import computing instance, a product quality review computing instance, a group print computing instance, an insights computing instance, a machine learning computing instance, or a fabric computing instance.

In some embodiments, the plurality of status triggers comprises at least one of a restart status trigger, a memory status trigger, a processing power status trigger, a workflow request status trigger, a workflow success status trigger, a workflow failure status trigger, or a workflow time status trigger.

In some embodiments, the plurality of interface components comprises at least one of a restart interface component, a memory interface component, a processing power interface component, a workflow request interface component, a workflow success interface component, a workflow failure interface component, or a workflow time interface component.

In some embodiments, the at least one processor is configured to determine that the first computing instance of the plurality of computing instances has been updated.

In some embodiments, the at least one processor is configured to generate an updated configuration specification based at least in part on the determination that the first computing instance has been updated.

In some embodiments, the first interface component is updated in real-time.

In some embodiments, the configuration specification identifies one or more workflows performed by the first computing instance of the plurality of computing instances.

In accordance with another aspect of the disclosure, a non-transitory computer-readable storage medium is provided. In some embodiments, the non-transitory computer-readable storage medium may include computer program code for execution by one or more processors of a device. In some embodiments, the computer program code is configured to, when executed by the one or more processors, cause the device to generate a configuration specification. In some embodiments, the configuration specification is associated with a plurality of computing instances. In some embodiments, the computer program code is configured to, when executed by the one or more processors, cause the device to receive a status trigger from one of the plurality of computing instances. In some embodiments, the status trigger is one of a plurality of status triggers. In some embodiments, the computer program code is configured to, when executed by the one or more processors, cause the device to parse the configuration specification to determine that the status trigger was received from a first computing instance of the plurality of computing instances. In some embodiments, the computer program code is configured to, when executed by the one or more processors, cause the device to parse the configuration specification to determine a first interface component of a plurality of interface components associated with the plurality of status trigger. In some embodiments, the first interface component is associated with the status trigger. In some embodiments, the computer program code is configured to, when executed by the one or more processors, cause the device to cause a user interface to be displayed, the user interface comprising the plurality of interface components. In some embodiments, the computer program code is configured to, when executed by the one or more processors, cause the first interface component of the plurality of interface components to be updated based at least in part on the status trigger.

In some embodiments, the plurality of interface components are arranged on the user interface in a first interface configuration of a plurality of interface configurations.

In some embodiments, the first interface configuration is based at least in part on a user type.

In some embodiments, the first interface configuration is based at least in part on the first computing instance.

In some embodiments, the plurality of computing instances comprises at least one of a reconditioning computing instance, an import computing instance, a product quality review computing instance, a group print computing instance, an insights computing instance, a machine learning computing instance, or a fabric computing instance.

In some embodiments, the plurality of status triggers comprises at least one of a restart status trigger, a memory status trigger, a processing power status trigger, a workflow request status trigger, a workflow success status trigger, a workflow failure status trigger, or a workflow time status trigger.

In some embodiments, the plurality of interface components comprises at least one of a restart interface component, a memory interface component, a processing power interface component, a workflow request interface component, a workflow success interface component, a workflow failure interface component, or a workflow time interface component.

In some embodiments, the computer program code is configured to, when executed by the one or more processors, cause the device to determine that the first computing instance of the plurality of computing instances has been updated.

In some embodiments, the computer program code is configured to, when executed by the one or more processors, cause the device to generate an updated configuration specification based at least in part on the determination that the first computing instance has been updated.

In some embodiments, the first interface component is updated in real-time.

In some embodiments, the configuration specification identifies one or more workflows performed by the first computing instance of the plurality of computing instances.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an operations processing system in accordance with one or more embodiments of the present disclosure;

FIG. 3 illustrates an exemplary block diagram of a computing instance in accordance with one or more embodiments of the present disclosure;

FIG. 4 illustrates an example user interface in accordance with one or more embodiments of the present disclosure;

FIG. 5 illustrates an example user interface configuration in accordance with one or more embodiments of the present disclosure;

FIG. 6 illustrates another example user interface configuration in accordance with one or more embodiments of the present disclosure;

FIG. 7 illustrates another example user interface configuration in accordance with one or more embodiments of the present disclosure;

FIG. 8 illustrates another example user interface configuration in accordance with one or more embodiments of the present disclosure; and

FIG. 9 illustrates a flow chart of an example method in accordance with one or more embodiments of the present disclosure.

### DETAILED DESCRIPTION

Example embodiments will be described more fully hereinafter with reference to the accompanying drawings, in which some, but not all embodiments of disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Example embodiments disclosed herein address technical problems associated with monitoring workflows based on status triggers. As would be understood by one skilled in the field to which this disclosure pertains, there are numerous example scenarios in which a user may need to monitor workflows based on status triggers.

In many computing applications, it is necessary to monitor a process performed by the computing application (e.g., workflows performed by the computing application). For example, it may be necessary to monitor a process performed by a computing application to ensure the computing application can reliably perform the process (e.g., the computing application consistently and accurately performs the process). As another example, it may be necessary to monitor a process performed by the computing application to track the computing resources that are consumed by performing the process (e.g., how many times the computing application performs the process, how much processing power is required to perform the process, and/or how much memory is required to perform the process).

Example solutions for monitoring a process performed by a computing application include, for example, monitoring various metrics and logs specific to the process being performed by the computing application in an ad hoc manner. However, such an example solution for monitoring a process performed by a computing application may be expensive and time consuming because resources must be regularly used to analyze the metrics and logs to monitor the process being performed by the computing application. For example, each time there is an error associated with the process, resources must be used to analyze the metrics and logs to determine the cause of the error and a solution to the error. Additionally, such an example solution for monitoring a process performed by a computing application may be difficult to scale (e.g., implement for several different process performed by one or more computing applications) because the metrics and logs needed to monitor one process may be different than another process.

Thus, to address these and/or other issues related to monitoring workflows based on status triggers, example systems, apparatuses, computer program products, and/or methods for monitoring workflows based on status triggers are disclosed herein. For example, an embodiment described herein includes a computer-implemented method may include generating a configuration specification. In some embodiments, the configuration specification is associated with a plurality of computing instances. In some embodiments, the computer-implemented method may include receiving a status trigger from one of the plurality of computing instances. In some embodiments, the status trigger is one of a plurality of status triggers. In some embodiments, the computer-implemented method may include parsing the configuration specification to determine that the status trigger was received from a first computing instance of the plurality of computing instances. In some embodiments, the computer-implemented method may include parsing the configuration specification to determine a first interface component of a plurality of interface components associated with the plurality of status trigger. In some embodiments, the first interface component is associated with the status trigger. In some embodiments, the computer-implemented method may include causing a user interface to be displayed, the user interface comprising the plurality of interface components. In some embodiments, the computer-implemented method may include causing the first interface component of the plurality of interface components to be updated based at least in part on the status trigger. Accordingly, the systems apparatuses, methods, and computer program products disclosed herein enable efficient and scalable monitoring of numerous computing instances configured to perform different workflows based on the configuration specification and the plurality of interface components.

### Example Apparatuses and Systems

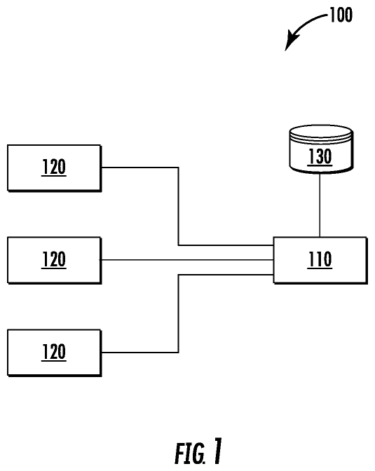

FIG. 1 illustrates an exemplary block diagram of an environment 100 in which embodiments of the present disclosure may operate. It will be appreciated that the environment 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of an exemplary block diagram of an environment 100 in which embodiments of the present disclosure may operate, numerous other configurations may also be used to implement embodiments of the present disclosure.

The environment 100 may include an operations processing system 110. The operations processing system 110 may comprise one or more servers, a server cluster, one or more network nodes, a cloud computing infrastructure, one or more desktop computers, one or more laptop computers, one or more mobile computing devices, one or more kiosks, one or more input terminals, some combination thereof, or the like.

The environment 100 may include a plurality of computing instances 120. While three of the plurality of computing instances 120 are illustrated in FIG. 1, it will be appreciated that this illustration is by way of example, and not by way of limitation, as the environment 100 may include additional plurality of computing instances 120. The plurality of computing instances 120 may each be embodied by any computing device, such as by way of non-limiting example, one or more servers, a server cluster, one or more network nodes, a cloud computing infrastructure, one or more desktop computers, one or more laptop computers, one or more mobile computing devices, one or more kiosks, one or more input terminals, some combination thereof, or the like.

The environment 100 may include one or more databases 130. The one or more databases 130 may be configured to receive, store, and/or transmit data. In some embodiments, the data may be received from the operations processing system 110 and/or the plurality of computing instances 120. Additionally, while FIG. 1 illustrates certain components as separate, standalone entities communicating directly with each other, various embodiments are not limited to this configuration. In other embodiments, one or more components may communicate over a network and/or share hardware or the like.

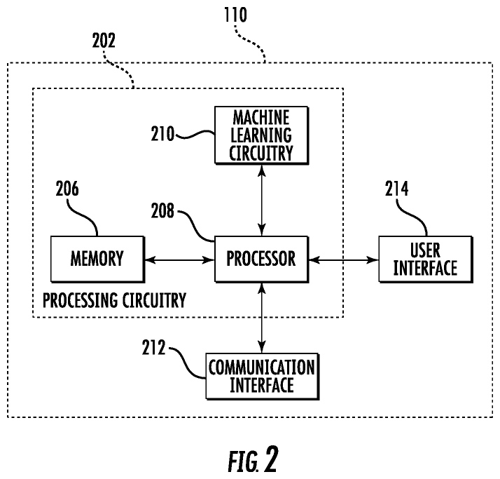

FIG. 2 illustrates a block diagram of an operations processing system 110 in accordance with some example embodiments. However, it should be noted that the components, devices, or elements illustrated in and described with respect to FIG. 2 below may not be mandatory and thus one or more may be omitted in certain embodiments. Additionally, some embodiments may include further or different components, devices, or elements beyond those illustrated in and described with respect to FIG. 2.

The operations processing system 110 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the operations processing system 110 in accordance with various example embodiments, and thus may provide means for performing functionalities of the operations processing system 110 in accordance with various example embodiments. The processing circuitry 202 may be configured to perform data processing, application execution and/or other processing and management services according to one or more example embodiments. In some embodiments, the operations processing system 110 or a portion(s) or component(s) thereof, such as the processing circuitry 202, may be embodied as or comprise a chip or chip set. In other words, the operations processing system 110 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The operations processing system 110 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some example embodiments, the processing circuitry 202 may include a processor 208 and, in some embodiments, such as that illustrated in FIG. 2, may further include memory 206 and machine learning circuitry 210. The processing circuitry 202 may be in communication with or otherwise control a communication interface 212 and/or a user interface 214. As such, the processing circuitry 202 may be embodied as a circuit chip (e.g., an integrated circuit chip) configured (e.g., with hardware, software or a combination of hardware and software) to perform operations described herein.

The processor 208 may be embodied in a number of different ways. For example, the processor 208 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 208 may comprise a plurality of processors. The plurality of processors may be in operative communication with each other and may be collectively configured to perform one or more functionalities of the operations processing system 110 as described herein. The plurality of processors may be embodied on a single computing device or distributed across a plurality of computing devices collectively configured to function as the operations processing system 110. In some example embodiments, the processor 208 may be configured to execute instructions stored in the memory 206 or otherwise accessible to the processor 208. As such, whether configured by hardware or by a combination of hardware and software, the processor 208 may represent an entity (e.g., physically embodied in circuitry-in the form of processing circuitry 202) capable of performing operations according to embodiments of the present disclosure while configured accordingly. Thus, for example, when the processor 208 is embodied as an ASIC, FPGA or the like, the processor 208 may be specifically configured hardware for conducting the operations described herein. Alternatively, as another example, when the processor 208 is embodied as an executor of software instructions, the instructions may specifically configure the processor 208 to perform one or more operations described herein.

In some example embodiments, the memory 206 may include one or more non-transitory memory devices such as, for example, volatile and/or non-volatile memory that may be either fixed or removable. In this regard, the memory 206 may comprise a non-transitory computer-readable storage medium. It will be appreciated that while the memory 206 is illustrated as a single memory, the memory 206 may comprise a plurality of memories. The plurality of memories may be embodied on a single computing device or may be distributed across a plurality of computing devices collectively configured to function as the operations processing system 110. The memory 206 may be configured to store information, data, applications, instructions and/or the like for enabling the operations processing system 110 to carry out various functions in accordance with one or more example embodiments. For example, the memory 206 may be configured to buffer input data for processing by the processor 208. Additionally or alternatively, the memory 206 may be configured to store instructions for execution by the processor 208. As yet another alternative, the memory 206 may include one or more databases that may store a variety of files, contents, or data sets. Among the contents of the memory 206, applications may be stored for execution by the processor 208 in order to carry out the functionality associated with each respective application. In some cases, the memory 206 may be in communication with one or more of the processor 208, communication interface 212, or the machine learning circuitry 210, or the user interface 214 via a bus(es) for passing information among components of the operations processing system 110.

In some example embodiments, the machine learning circuitry 210 may include hardware components designed or configured to request, receive, process, generate, and transmit data, data structures, control signals, and electronic information for executing a trained machine learning model. In some example embodiments, the memory 206 may be in communication with one or more of the memory 206, the processor 208, the communication interface 212, or the user interface 214 via a bus(es) for passing information among components of the operations processing system 110.

In some example embodiments, the operations processing system 110 may further include a communication interface 212. In some cases, the communication interface 212 may be any means such as a device or circuitry embodied in either hardware, or a combination of hardware and software that is configured to receive and/or transmit data from/to a network and/or any other device or circuitry in communication with the processing circuitry 202. By way of example, the communication interface 212 may be configured to enable the operations processing system 110 to communicate with the plurality of computing instances 120 and/or other computing devices. Accordingly, the communication interface 212 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the operations processing system 110 may further include a user interface 214. The user interface 214 may be in communication with the processing circuitry 202 to receive an indication of a user input at the user interface 214 (e.g., a user selection) and/or to provide an audible, visual, mechanical, and/or other output to the user. As such, the user interface 214 may include, for example, a keyboard, a mouse, a joystick, a display, a touch screen display, a microphone, a speaker, and/or other input/output mechanisms. As such, the user interface 214 may, in some example embodiments, provide means for a user to access and interact with the operations processing system 110 in accordance with various example embodiments.

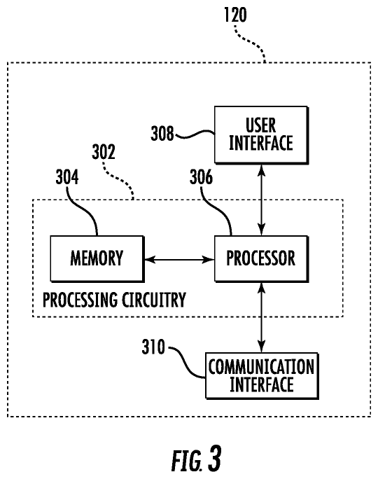

FIG. 3 illustrates a block diagram of each of the plurality of computing instances 120 in accordance with some example embodiments. However, it should be noted that the components, devices or elements illustrated in and described with respect to FIG. 3 below may not be mandatory and thus some may be omitted in certain embodiments. Additionally, some embodiments may include further or different components, devices or elements beyond those illustrated in and described with respect to FIG. 3.

Referring now to FIG. 3, a block diagram of each of the plurality of computing instances 120 is illustrated. In some embodiments, each of the plurality of computing instances 120 may include or otherwise be in communication with processing circuitry 302 that is configurable to perform actions in accordance with one or more example embodiments disclosed herein. In this regard, the processing circuitry 302 may be configured to perform and/or control performance of one or more functionalities of each of the plurality of computing instances 120 in accordance with various example embodiments, and thus may provide means for performing functionalities of each of the plurality of computing instances 120 in accordance with various example embodiments. The processing circuitry 302 may be configured to perform data processing, application execution and/or other processing and management services according to one or more example embodiments. In some embodiments, each of the plurality of computing instances 120 or a portion(s) or component(s) thereof, such as the processing circuitry 302, may be embodied as or comprise a chip or chip set. In other words, each of the plurality of computing instances 120 or the processing circuitry 302 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In some embodiments, each of the plurality of computing instances 120 or the processing circuitry 302 may therefore, in some cases, be configured to implement an embodiment of the disclosure on a single chip or as a single “system on a chip.” As such, in some cases, a chip or chipset may constitute means for performing one or more operations for providing the functionalities described herein.

In some example embodiments, the processing circuitry 302 may include a processor 306 and, in some embodiments, such as that illustrated in FIG. 3, may further include memory 304. The processing circuitry 302 may be in communication with or otherwise control a user interface 308, and/or a communication interface 310. As such, the processing circuitry 302 may be embodied as a circuit chip (e.g., an integrated circuit chip) configured (e.g., with hardware, software or a combination of hardware and software) to perform operations described herein.

The processor 306 may be embodied in a number of different ways. For example, the processor 306 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 306 may comprise a plurality of processors. The plurality of processors may be in operative communication with each other and may be collectively configured to perform one or more functionalities of each of the plurality of computing instances 120 as described herein. In some example embodiments, the processor 306 may be configured to execute instructions stored in the memory 304 or otherwise accessible to the processor 306. As such, whether configured by hardware or by a combination of hardware and software, the processor 306 may represent an entity (e.g., physically embodied in circuitry-in the form of processing circuitry 302) capable of performing operations according to embodiments of the present disclosure while configured accordingly. Thus, for example, when the processor 306 is embodied as an ASIC, FPGA or the like, the processor 306 may be specifically configured hardware for conducting the operations described herein. Alternatively, as another example, when the processor 306 is embodied as an executor of software instructions, the instructions may specifically configure the processor 306 to perform one or more operations described herein.

In some example embodiments, the memory 304 may include one or more non-transitory memory devices such as, for example, volatile and/or non-volatile memory that may be either fixed or removable. In this regard, the memory 304 may comprise a non-transitory computer-readable storage medium. It will be appreciated that while the memory 304 is illustrated as a single memory, the memory 304 may comprise a plurality of memories. The memory 304 may be configured to store information, data, applications, instructions and/or the like for enabling each of the plurality of computing instances 120 to carry out various functions in accordance with one or more example embodiments. For example, the memory 304 may be configured to buffer input data for processing by the processor 306. Additionally or alternatively, the memory 304 may be configured to store instructions for execution by the processor 306. As yet another alternative, the memory 304 may include one or more databases that may store a variety of files, contents or data sets. Among the contents of the memory 304, applications may be stored for execution by the processor 306 in order to carry out the functionality associated with each respective application. In some cases, the memory 304 may be in communication with one or more of the processor 306, user interface 308, and/or communication interface 310 via a bus(es) for passing information among components of each of the plurality of computing instances 120.

The user interface 308 may be in communication with the processing circuitry 302 to receive an indication of a user input at the user interface 308 (e.g., a user selection) and/or to provide an audible, visual, mechanical or other output to the user. As such, the user interface 308 may include, for example, a keyboard, a mouse, a joystick, a display, a touch screen display, a microphone, a speaker, and/or other input/output mechanisms. As such, the user interface 308 may, in some example embodiments, provide means for a user to access and interact with each of the plurality of computing instances 120 and/or the operations processing system 110 in accordance with various example embodiments.

The communication interface 310 may include one or more interface mechanisms for enabling communication with other devices and/or networks. In some cases, the communication interface 310 may be any means such as a device or circuitry embodied in either hardware, or a combination of hardware and software that is configured to receive and/or transmit data from/to a network and/or any other device or module in communication with the processing circuitry 302. By way of example, the communication interface 310 may be configured to enable each of the plurality of computing instances 120 to communicate with the operations processing system 110 and/or other computing devices. Accordingly, the communication interface 310 may, for example, include an antenna (or multiple antennas) and supporting hardware and/or software for enabling communications with a wireless communication network (e.g., a wireless local area network, cellular network, global positing system network, and/or the like) and/or a communication modem or other hardware/software for supporting communication via cable, digital subscriber line (DSL), universal serial bus (USB), Ethernet or other methods.

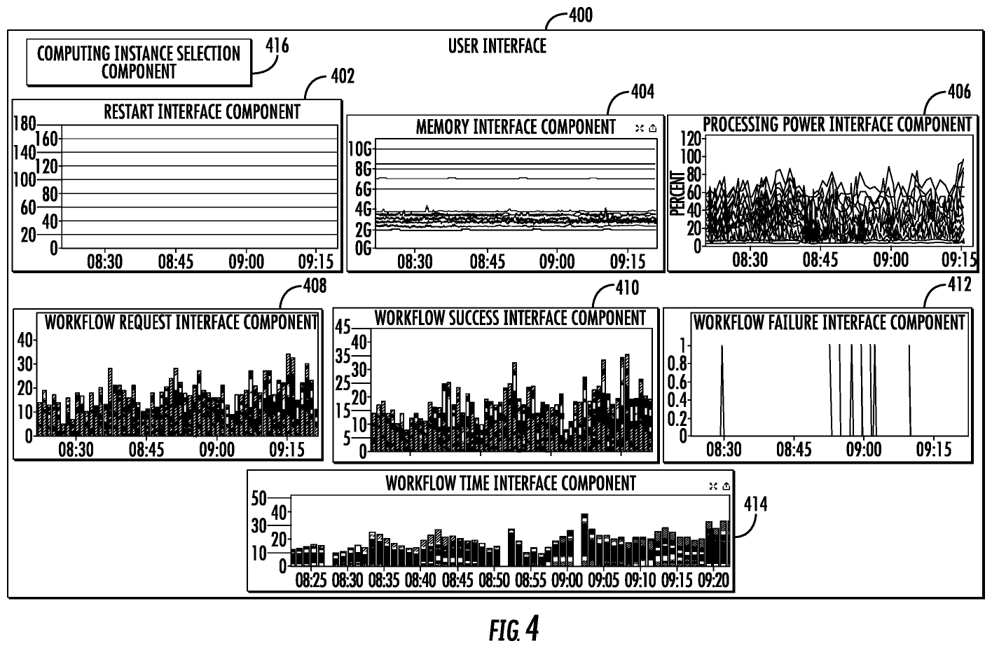

With reference to FIGS. 1-8, in some embodiments, the operations processing system 110 may be configured to generate a configuration specification. In some embodiments, the configuration specification may be associated with the plurality of computing instances 120. In this regard, for example, the configuration specification may identify one or more workflows performed by each of the plurality of computing instances 120.

In some embodiments, each of the plurality of computing instances 120 may be configured to perform one or more workflows. In some embodiments, the plurality of computing instances 120 may include a reconditioning computing instance configured to perform a reconditioning workflow. For example, the reconditioning computing instance may be configured to perform a reconditioning workflow that transforms a document from a first format to a second format (e.g., convert a document from a DOCX format to a PDF format). Additionally or alternatively, the reconditioning computing instance may be configured to perform a reconditioning workflow that adds metadata to a document (e.g., the reconditioning workflow may add a watermark to the document). In some embodiments, the plurality of computing instances 120 may include an import computing instance configured to perform an import workflow. For example, the import computing instance may be configured to perform an import workflow that imports a document to the computing instance from another computing instance and/or a separate computing device (e.g., a first computing instance imports a document from a second computing instance in the plurality of computing instances 120).

In some embodiments, the plurality of computing instances 120 may include a product quality review computing instance configured to perform a product quality review workflow. For example, the product quality review computing instance may be configured to perform a product quality review workflow that performs a quality analysis related to a particular product. In some embodiments, the plurality of computing instances 120 may include an insights computing instance configured to perform an insights workflow. For example, the insights computing instance may be configured to perform an insights workflow that derives insights from one or more datasets (e.g., one or more datasets stored in the one or more databases 130).

In some embodiments, the plurality of computing instances 120 may include a group print computing instance configured to perform a group print workflow. In some embodiments, the plurality of computing instances 120 may include a machine learning computing instance configured to perform a machine learning workflow. In some embodiments, the plurality of computing instances 120 may include a fabric computing instance configured to perform a fabric workflow.

In some embodiments, the one or more workflows may comprise one or more services that are used to perform the workflow. For example, at least one of the one or more workflows may include one or more queue services (e.g., a dead letter queue service). As another example, at least one of the one or more workflows may include one or more datastore services (e.g., a time series datastore). As another example, at least one of the one or more workflows may include one or more notification services (e.g., a two way notification service). As another example, at least one of the one or more workflows may include one or more sub-computing instance services (e.g., a sub-computing instance that performs a portion of the workflow).

In some embodiments, the operations processing system 110 may be configured to receive status triggers from the plurality of computing instances 120. In this regard, for example, the operations processing system 110 may be configured to receive a status trigger from at least one of the plurality of computing instances 120. In some embodiments, the status trigger may indicate a status associated with a particular workflow being performed by the one of the plurality of computing instances 120. In some embodiments, the status trigger may include an identifier that associates the status trigger with one of the plurality of computing instances 120. For example, a status trigger received by the operations processing system 110 from the reconditioning computing instance may include a reconditioning computing instance identifier.

In some embodiments, the status trigger may be one of a plurality of status triggers. In some embodiments, at least some of the plurality of computing instances 120 may be associated with only a portion of the plurality of status triggers. In this regard, for example, some of the plurality of computing instances 120 may be configured to send only some of the plurality of status triggers to the operations processing system 110. For example, a machine learning computing instance may not be associated with a workflow request status trigger (e.g., a machine learning computing instance may not be configured to transmit a workflow request status trigger to the operations processing system 110).

In some embodiments, the plurality of status triggers may include a restart status trigger. In this regard, a restart status trigger may indicate that a computing instance has restarted a workflow. Additionally or alternatively, a restart status trigger may indicate that a computing instance has restarted (e.g., the computing instance is rebooting). For example, a restart status trigger may indicate that a reconditioning computing instance has restarted a reconditioning workflow. In some embodiments, the plurality of status triggers may include a memory status trigger. In this regard, a memory status trigger may indicate how much memory a computing instance is consuming when the computing instance is performing a workflow. For example, a memory status trigger may indicate how much memory an insights computing instance uses when it is performing an insights workflow. In some embodiments, the plurality of status triggers may include a processing power status trigger. In this regard, a processing power status trigger may indicate how much processing power a computing instance is consuming when the computing instance is performing a workflow. For example, a processing power trigger may indicate how much processing power a machine learning computing instance uses when it is performing a machine learning workflow.

In some embodiments, the plurality of status triggers may include a workflow request status trigger. In this regard, a workflow request status trigger may indicate when a computing instance has received a request to perform a workflow. For example, a workflow request status trigger may indicate that a machine learning computing instance has been requested to perform a machine learning workflow. In some embodiments, the plurality of status triggers may include a workflow success status trigger. In this regard, a workflow success status trigger may indicate if a workflow performed by a computing instance was successfully completed. For example, a workflow success status trigger may indicate that a reconditioning computing instance successfully completed a reconditioning workflow that transformed a document from a first format to a second format.

In some embodiments, the plurality of status triggers may include a workflow failure status trigger. In this regard, a workflow failure status trigger may indicate if a workflow performed by a computing instance failed. For example, a workflow failure status trigger may indicate that an import computing instance failed to complete an import workflow that was configured to import a document from another computing instance. In some embodiments, the plurality of status triggers may include a workflow time status trigger. In this regard, a workflow time status trigger may indicate how much time it took for a computing instance to perform a workflow. For example, a workflow time status trigger may indicate that a reconditioning computing instance took 1 second to complete a reconditioning workflow that transformed a document from a first format to a second format.

In some embodiments, the operations processing system 110 may be configured to parse the configuration specification to determine that a status trigger was received from a first computing instance of the plurality of computing instances 120. Said differently, since the operations processing system 110 may be configured to receive status triggers from the plurality of computing instances 120, the operations processing system 110 may be configured to parse the configuration specification to determine which of the plurality of computing instances 120 a status trigger was received from. In this regard, for example, the operations processing system 110 may parse the configuration specification based on an identifier included in a status trigger to determine which of the plurality of computing instances 120 the status trigger was received from (e.g., the operations processing system 110 may compare the identifier included in the status trigger with identifiers included in the configuration specification for each of the plurality of computing instances 120). For example, if the operations processing system 110 receives a workflow request status trigger having a reconditioning computing instance identifier, the operations processing system 110 may parse the configuration specification to determine that the workflow request status trigger came from a first computing instance (e.g., a reconditioning computing instance) of the plurality of computing instances 120.

In some embodiments, the operations processing system 110 may be configured to parse the configuration specification to determine a first interface component of a plurality of interface components associated with the plurality of status triggers. In some embodiments, the first interface component may be associated with the status trigger received by the operations processing system 110. Said differently, each of the plurality of status triggers may be associated with a corresponding interface component of a plurality of interface components. For example, a workflow success status trigger may be associated with a workflow success interface component 410.

In some embodiments, the operations processing system 110 may be configured to cause a user interface 400 to be displayed. In some embodiments, the user interface 400 may be configured to display the plurality of interface components associated with a first computing instance of the plurality of computing instances 120. For example, the user interface 400 may include a restart interface component 402 configured to display restart status triggers. As another example, the user interface 400 may include a memory interface component 404 configured to display memory status triggers. As another example, the user interface 400 may include a processing power interface component 406 configured to display processing power status triggers. As another example, the user interface 400 may include a workflow request interface component 408 configured to display workflow request status triggers. As another example, the user interface 400 may include a workflow success interface component 410 configured to display workflow success status triggers. As another example, the user interface 400 may include a workflow failure interface component 412 configured to display workflow failure status triggers. As another example, the user interface 400 may include a workflow time interface component 414 configured to display workflow time status triggers.

In some embodiments, the user interface 400 may include a computing instance selection component 416. In some embodiments, the computing instance selection component 416 may be configured to be selected such that a user interacting with the user interface 400 may be able to view interface components associated with different computing instances of the plurality of computing instances 120. Said differently, the user interface 400 may be configured to display the plurality of interface components associated with each of the plurality of computing instances 120. For example, the user interface 400 may be configured to display the plurality of interface components associated with a first computing instance (e.g., a reconditioning computing instance) and, in response to selection of the computing instance selection component 416, may be configured to display the plurality of interface components associated with a second computing instance (e.g., an import computing instance) of the plurality of computing instances 120.

In some embodiments, the operations processing system 110 may be configured to cause a first interface component of the plurality of interface components to be updated based at least in part on a status trigger. Said differently, the operations processing system 110 may be configured to update each of the plurality of interface components based at least in part on corresponding status triggers received by the operations processing system 110. For example, if the operations processing system 110 receives a restart status trigger and a memory status trigger, the operations processing system 110 may be configured to update the restart interface component 402 based at least in part on the restart status trigger and the memory interface component 404 based at least in part on the memory status trigger. In some embodiments, the operations processing system 110 may be configured to update the plurality of interface components in real-time (e.g., an interface component is updated as a status trigger associated with the interface component is received by the operations processing system 110).

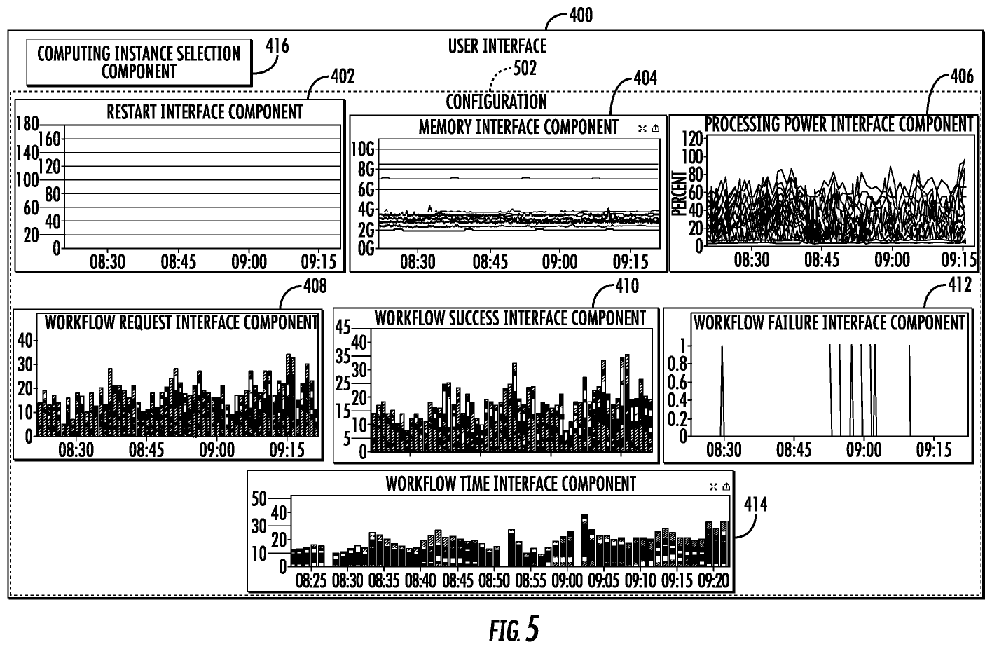

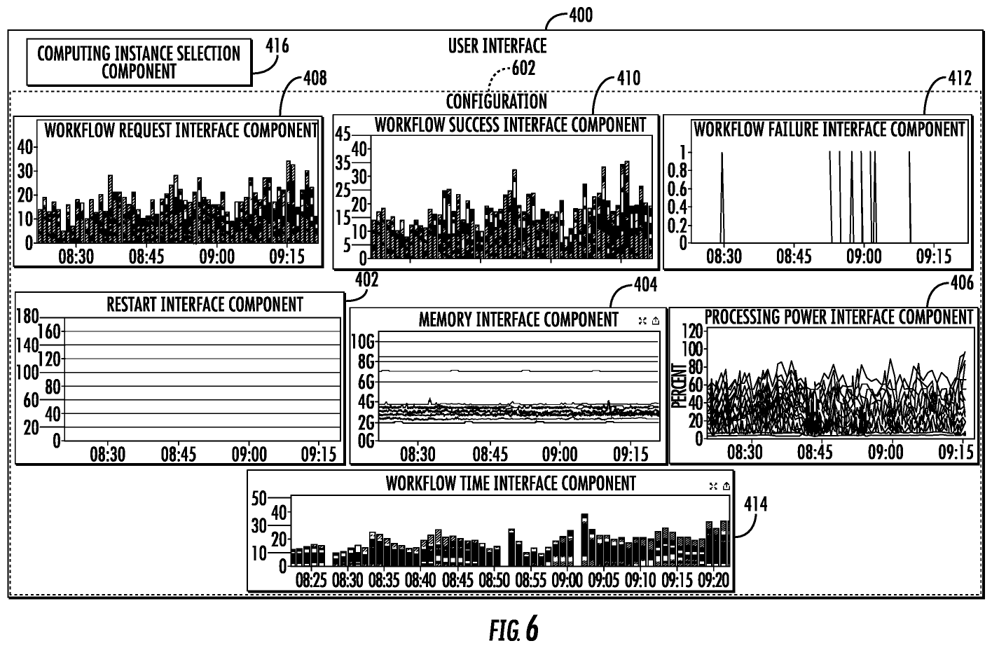

In some embodiments, the operations processing system 110 may be configured to arrange the plurality of interface components on the user interface 400 in a first interface configuration of a plurality of interface configurations. In some embodiments, the first interface configuration may be based at least in part on a user type (e.g., a user type of a user interacting with the user interface 400). For example, as illustrated in FIG. 5, the arrangement of the plurality of interface components in first configuration 502 may be based at least in part on a development user type. In this regard, for example, the restart interface component 402, the memory interface component 404, and/or the processing power interface component 406 may be arranged in a top portion of the user interface 400 (e.g., the top portion being a position of priority). For example, the restart interface component 402, the memory interface component 404, and/or the processing power interface component 406 may be arranged in the top portion of the user interface 400 because the restart interface component 402, the memory interface component 404, and/or the processing power interface component 406 may be the most likely interface components of the plurality of interface components that a user associated with a development user type would view. As another example, as illustrated in FIG. 6, the arrangement of the plurality of interface components in second configuration 602 may be based at least in part on a quality assurance user type. In this regard, for example, the workflow request interface component 408, the workflow success interface component 410, and/or the workflow failure interface component 412 may be arranged in a top portion of the user interface 400. For example, the workflow request interface component 408, the workflow success interface component 410, and/or the workflow failure interface component 412 may be arranged in the top portion of the user interface 400 because the workflow request interface component 408, the workflow success interface component 410, and/or the workflow failure interface component 412 may be the most likely interface components of the plurality of interface components that a user associated with a quality assurance user type would view.

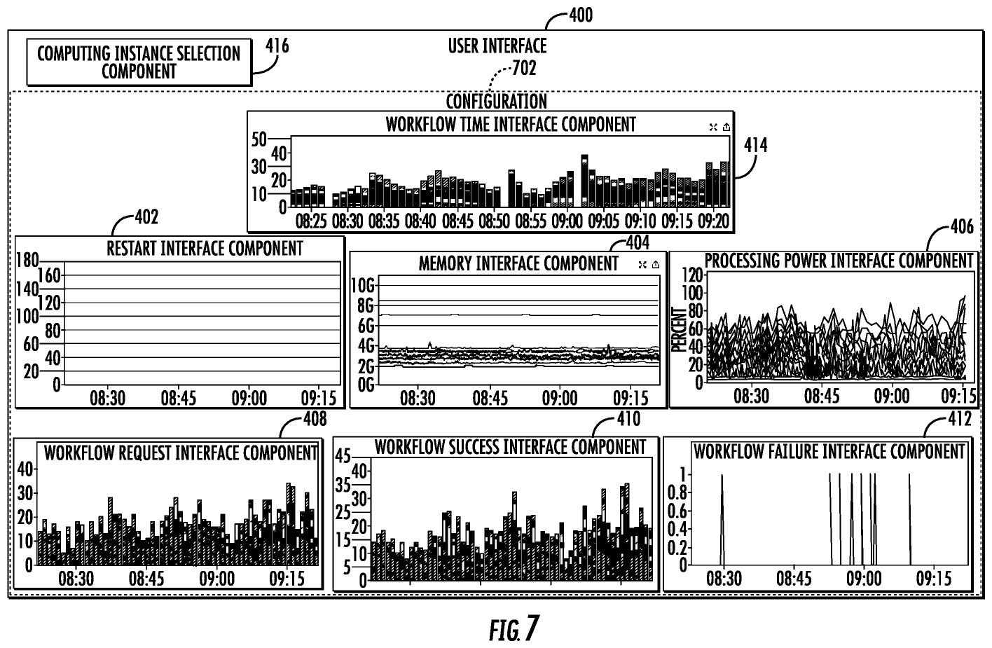

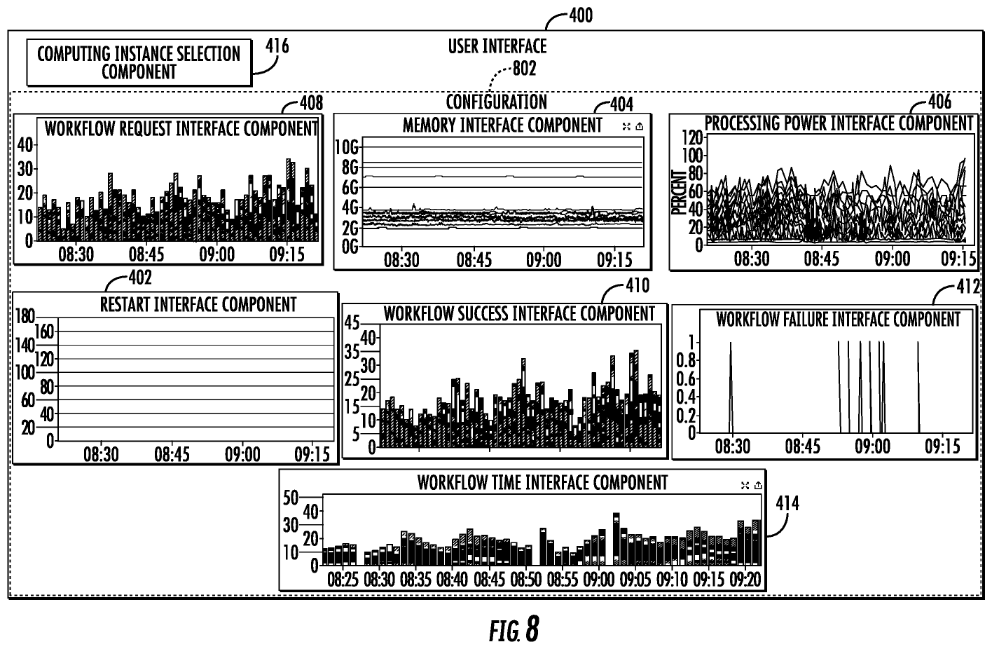

In some embodiments, the first interface configuration may be based at least in part on the first computing instance (e.g., the computing instance associated with the plurality of interface components displayed on the user interface 400). For example, as illustrated in FIG. 7, the arrangement of the plurality of interface components in third configuration 702 may be based at least in part on the workflow time status trigger being the most important status trigger to track for the first computing instance. For example, the workflow time status trigger may be the most important status trigger to track for the first computing instance since the workflows performed by the first computing instance must be completed in a particular time period. In this regard, for example, the workflow time interface component 414 may be arranged in the top portion of the user interface 400. As another example, as illustrated in FIG. 8, the arrangement of the plurality of interface components in fourth configuration 802 may be based at least in part on the workflow request status trigger, the memory status trigger, and/or the processing power status trigger being the most important status triggers to track for the first computing instance. For example, the workflow request status trigger, the memory status trigger, and/or the processing power status trigger may be the most important status triggers to track for the first computing instance because the first computing instance has limited memory and processing power so workflow request status triggers, memory status triggers, and/or processing power status triggers must be tracked to ensure the first computing instance is not overwhelmed (e.g., ensure that the first computing instance has enough processing power and/or memory to process all of the workflow requests). In this regard, for example, the workflow request interface component 408, the memory interface component 404, and/or the processing power interface component 406 may be arranged in the top portion of the user interface 400.

In some embodiments, the operations processing system 110 may be configured to determine that a first computing instance of the plurality of computing instances 120 has been updated. In this regard, the first computing instance may be updated such that it is configured to perform a different workflow that it was previously performing. For example, the first computing instance may initially be configured to perform a reconditioning workflow and, after being updated, the first computing instance may be configured to perform an import workflow. In some embodiments, the operations processing system 110 may be configured to generate an updated configuration specification based at least in part on the determination that the first computing instance has been updated. For example, the updated configuration specification may identify that the first computing instance of the plurality of computing instances 120 may perform an import workflow.

### Example Methods

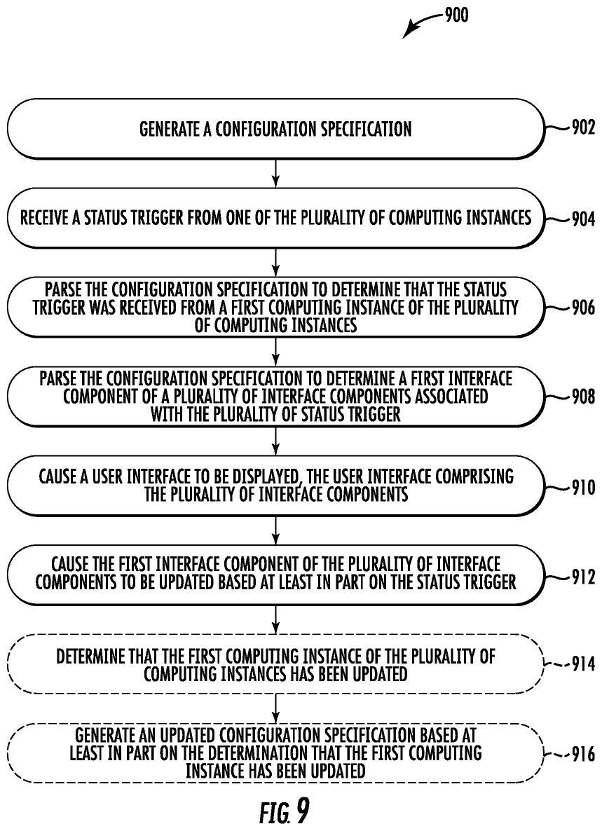

Referring now to FIG. 9, a flowchart providing an example computer-implemented method 900 is illustrated. In this regard, FIG. 9 illustrates operations that may be performed by operations processing system 110 and/or components of the operations processing system 110.

As shown in block 902, the computer-implemented method 900 may include generating a configuration specification. As described above, in some embodiments, the configuration specification may be associated with the plurality of computing instances. In this regard, for example, the configuration specification may identify one or more workflows performed by each of the plurality of computing instances.

As described above, in some embodiments, each of the plurality of computing instances may be configured to perform one or more workflows. In some embodiments, the plurality of computing instances may include a reconditioning computing instance configured to perform a reconditioning workflow. For example, the reconditioning computing instance may be configured to perform a reconditioning workflow that transforms a document from a first format to a second format (e.g., convert a document from a DOCX format to a PDF format). Additionally or alternatively, the reconditioning computing instance may be configured to perform a reconditioning workflow that adds metadata to a document (e.g., the reconditioning workflow may add a watermark to the document). In some embodiments, the plurality of computing instances may include an import computing instance configured to perform an import workflow. For example, the import computing instance may be configured to perform an import workflow that imports a document to the computing instance from another computing instance and/or a separate computing device (e.g., a first computing instance imports a document from a second computing instance in the plurality of computing instances).

In some embodiments, the plurality of computing instances may include a product quality review computing instance configured to perform a product quality review workflow. For example, the product quality review computing instance may be configured to perform a product quality review workflow that performs a quality analysis related to a particular product. In some embodiments, the plurality of computing instances may include an insights computing instance configured to perform an insights workflow. For example, the insights computing instance may be configured to perform an insights workflow that derives insights from one or more datasets (e.g., one or more datasets stored in the one or more databases).

In some embodiments, the plurality of computing instances may include a group print computing instance configured to perform a group print workflow. In some embodiments, the plurality of computing instances may include a machine learning computing instance configured to perform a machine learning workflow. In some embodiments, the plurality of computing instances may include a fabric computing instance configured to perform a fabric workflow.

As shown in block 904, the computer-implemented method 900 may include receiving a status trigger from one of the plurality of computing instances. As described above, in some embodiments, the status trigger may indicate a status associated with a particular workflow being performed by the one of the plurality of computing instances. In some embodiments, the status trigger may include an identifier that associates the status trigger with one of the plurality of computing instances. For example, a status trigger received from the reconditioning computing instance may include a reconditioning computing instance identifier.

In some embodiments, the status trigger may be one of a plurality of status triggers. In some embodiments, at least some of the plurality of computing instances may be associated with only a portion of the plurality of status triggers. In this regard, for example, some of the plurality of computing instances may be configured to send only some of the plurality of status triggers. For example, a machine learning computing instance may not be associated with a workflow request status trigger (e.g., a machine learning computing instance may not be configured to transmit a workflow request status trigger).

In some embodiments, the plurality of status triggers may include a restart status trigger. In this regard, a restart status trigger may indicate that a computing instance has restarted a workflow. Additionally or alternatively, a restart status trigger may indicate that a computing instance has restarted (e.g., the computing instance is rebooting). For example, a restart status trigger may indicate that a reconditioning computing instance has restarted a reconditioning workflow. In some embodiments, the plurality of status triggers may include a memory status trigger. In this regard, a memory status trigger may indicate how much memory a computing instance is consuming when the computing instance is performing a workflow. For example, a memory status trigger may indicate how much memory an insights computing instance uses when it is performing an insights workflow. In some embodiments, the plurality of status triggers may include a processing power status trigger. In this regard, a processing power status trigger may indicate how much processing power a computing instance is consuming when the computing instance is performing a workflow. For example, a processing power trigger may indicate how much processing power a machine learning computing instance uses when it is performing a machine learning workflow.

In some embodiments, the plurality of status triggers may include a workflow request status trigger. In this regard, a workflow request status trigger may indicate when a computing instance has received a request to perform a workflow. For example, a workflow request status trigger may indicate that a machine learning computing instance has been requested to perform a machine learning workflow. In some embodiments, the plurality of status triggers may include a workflow success status trigger. In this regard, a workflow success status trigger may indicate if a workflow performed by a computing instance was successfully completed. For example, a workflow success status trigger may indicate that a reconditioning computing instance successfully completed a reconditioning workflow that transformed a document from a first format to a second format.

In some embodiments, the plurality of status triggers may include a workflow failure status trigger. In this regard, a workflow failure status trigger may indicate if a workflow performed by a computing instance failed. For example, a workflow failure status trigger may indicate that an import computing instance failed to complete an import workflow that was configured to import a document from another computing instance. In some embodiments, the plurality of status triggers may include a workflow time status trigger. In this regard, a workflow time status trigger may indicate how much time it took for a computing instance to perform a workflow. For example, a workflow time status trigger may indicate that a reconditioning computing instance took 1 second to complete a reconditioning workflow that transformed a document from a first format to a second format.

As shown in block 906, the computer-implemented method 900 may include parsing the configuration specification to determine that the status trigger was received from a first computing instance of the plurality of computing instances. As described above, since status triggers may be received from the plurality of computing instances, t the configuration specification may be parsed to determine which of the plurality of computing instances a status trigger was received from. In this regard, for example, the configuration specification may be parsed based on an identifier included in a status trigger to determine which of the plurality of computing instances the status trigger was received from (e.g., the identifier included in the status trigger may be compared with identifiers included in the configuration specification for each of the plurality of computing instances). For example, if a workflow request status trigger is received having a reconditioning computing instance identifier, the configuration specification may be parsed to determine that the workflow request status trigger came from a first computing instance (e.g., a reconditioning computing instance) of the plurality of computing instances.

As shown in block 908, the computer-implemented method 900 may include parsing the configuration specification to determine a first interface component of a plurality of interface components associated with the plurality of status trigger. As described above, in some embodiments, the first interface component may be associated with the received status trigger. Said differently, each of the plurality of status triggers may be associated with a corresponding interface component of a plurality of interface components. For example, a workflow success status trigger may be associated with a workflow success interface component.

As shown in block 910, the computer-implemented method 900 may include causing a user interface to be displayed, the user interface comprising the plurality of interface components. As described above, in some embodiments, the user interface may be configured to display the plurality of interface components associated with a first computing instance of the plurality of computing instances. For example, the user interface may include a restart interface component configured to display restart status triggers. As another example, the user interface may include a memory interface component configured to display memory status triggers. As another example, the user interface may include a processing power interface component configured to display processing power status triggers. As another example, the user interface may include a workflow request interface component configured to display workflow request status triggers. As another example, the user interface may include a workflow success interface component configured to display workflow success status triggers. As another example, the user interface may include a workflow failure interface component configured to display workflow failure status triggers. As another example, the user interface may include a workflow time interface component configured to display workflow time status triggers.

In some embodiments, the user interface may include a computing instance selection component. In some embodiments, the computing instance selection component may be configured to be selected such that a user interacting with the user interface may be able to view interface components associated with different computing instances of the plurality of computing instances. Said differently, the user interface may be configured to display the plurality of interface components associated with each of the plurality of computing instances. For example, the user interface may be configured to display the plurality of interface components associated with a first computing instance (e.g., a reconditioning computing instance) and, in response to selection of the computing instance selection component, may be configured to display the plurality of interface components associated with a second computing instance (e.g., an import computing instance) of the plurality of computing instances.

As shown in block 912, the computer-implemented method 900 may include causing the first interface component of the plurality of interface components to be updated based at least in part on the status trigger. As described above, in some embodiments, each of the plurality of interface components may be updated based at least in part on corresponding status triggers. For example, if a restart status trigger and a memory status trigger are received, restart interface component may be updated based at least in part on the restart status trigger and the memory interface component may be updated based at least in part on the memory status trigger. In some embodiments, the plurality of interface components may be updated in real-time (e.g., an interface component is updated as a status trigger associated with the interface component is received).

In some embodiments, the plurality of interface components may be arranged on the user interface in a first interface configuration of a plurality of interface configurations. In some embodiments, the first interface configuration may be based at least in part on a user type (e.g., a user type of a user interacting with the user interface). For example, the arrangement of the plurality of interface components in a first configuration may be based at least in part on a development user type. In this regard, for example, the restart interface component, the memory interface component, and/or the processing power interface component may be arranged in a top portion of the user interface (e.g., the top portion being a position of priority). For example, the restart interface component, the memory interface component, and/or the processing power interface component may be arranged in the top portion of the user interface because the restart interface component, the memory interface component, and/or the processing power interface component may be the most likely interface components of the plurality of interface components that a user associated with a development user type would view. As another example, the arrangement of the plurality of interface components in a second configuration may be based at least in part on a quality assurance user type. In this regard, for example, the workflow request interface component, the workflow success interface component, and/or the workflow failure interface component may be arranged in a top portion of the user interface. For example, the workflow request interface component, the workflow success interface component, and/or the workflow failure interface component may be arranged in the top portion of the user interface because the workflow request interface component, the workflow success interface component, and/or the workflow failure interface component may be the most likely interface components of the plurality of interface components that a user associated with a quality assurance user type would view.

In some embodiments, the first interface configuration may be based at least in part on the first computing instance (e.g., the computing instance associated with the plurality of interface components displayed on the user interface). For example, the arrangement of the plurality of interface components in a third configuration may be based at least in part on the workflow time status trigger being the most important status trigger to track for the first computing instance. For example, the workflow time status trigger may be the most important status trigger to track for the first computing instance since the workflows performed by the first computing instance must be completed in a particular time period. In this regard, for example, the workflow time interface component may be arranged in the top portion of the user interface. As another example, the arrangement of the plurality of interface components in a fourth configuration may be based at least in part on the workflow request status trigger, the memory status trigger, and/or the processing power status trigger being the most important status triggers to track for the first computing instance. For example, the workflow request status trigger, the memory status trigger, and/or the processing power status trigger may be the most important status triggers to track for the first computing instance because the first computing instance has limited memory and processing power so workflow request status triggers, memory status triggers, and/or processing power status triggers must be tracked to ensure the first computing instance is not overwhelmed (e.g., ensure that the first computing instance has enough processing power and/or memory to process all of the workflow requests). In this regard, for example, the workflow request interface component, the memory interface component, and/or the processing power interface component may be arranged in the top portion of the user interface.

As shown in block 914, the computer-implemented method 900 may optionally include determining that the first computing instance of the plurality of computing instances has been updated. As described above, in some embodiments, the first computing instance may be updated such that it is configured to perform a different workflow that it was previously performing. For example, the first computing instance may initially be configured to perform a reconditioning workflow and, after being updated, the first computing instance may be configured to perform an import workflow

As shown in block 916, the computer-implemented method 900 may optionally include generating an updated configuration specification based at least in part on the determination that the first computing instance has been updated. As described above, for example, the updated configuration specification may identify that the first computing instance of the plurality of computing instances may perform an import workflow.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

That which is claimed:

1. A computer-implemented method comprising:
generating a configuration specification, wherein the configuration specification is associated with a plurality of computing instances;
receiving a status trigger from one of the plurality of computing instances, wherein the status trigger is one of a plurality of status triggers;
parsing the configuration specification to determine that the status trigger was received from a first computing instance of the plurality of computing instances;
parsing the configuration specification to determine a first interface component of a plurality of interface components associated with the plurality of status trigger, wherein the first interface component is associated with the status trigger;
causing a user interface to be displayed, the user interface comprising the plurality of interface components; and
causing the first interface component of the plurality of interface components to be updated based at least in part on the status trigger.

2. The computer-implemented method of claim 1, wherein the plurality of interface components are arranged on the user interface in a first interface configuration of a plurality of interface configurations.

3. The computer-implemented method of claim 2, wherein the first interface configuration is based at least in part on a user type.

4. The computer-implemented method of claim 2, wherein the first interface configuration is based at least in part on the first computing instance.

5. The computer-implemented method of claim 1, wherein the plurality of computing instances comprises at least one of a reconditioning computing instance, an import computing instance, a product quality review computing instance, a group print computing instance, an insights computing instance, a machine learning computing instance, or a fabric computing instance.

6. The computer-implemented method of claim 1, wherein the plurality of status triggers comprises at least one of a restart status trigger, a memory status trigger, a processing power status trigger, a workflow request status trigger, a workflow success status trigger, a workflow failure status trigger, or a workflow time status trigger.

7. The computer-implemented method of claim 1, wherein the plurality of interface components comprises at least one of a restart interface component, a memory interface component, a processing power interface component, a workflow request interface component, a workflow success interface component, a workflow failure interface component, or a workflow time interface component.

8. The computer-implemented method of claim 1, further comprising:
determining that the first computing instance of the plurality of computing instances has been updated; and
generating an updated configuration specification based at least in part on the determination that the first computing instance has been updated.

9. The computer-implemented method of claim 1, wherein the first interface component is updated in real-time.

10. The computer-implemented method of claim 1, wherein the configuration specification identifies one or more workflows performed by the first computing instance of the plurality of computing instances.

11. An apparatus comprising at least one processor and at least one memory coupled to the at least one processor, wherein the at least one processor is configured to:
generate a configuration specification, wherein the configuration specification is associated with a plurality of computing instances;
receive a status trigger from one of the plurality of computing instances, wherein the status trigger is one of a plurality of status triggers;
parse the configuration specification to determine that the status trigger was received from a first computing instance of the plurality of computing instances;
parse the configuration specification to determine a first interface component of a plurality of interface components associated with the plurality of status trigger, wherein the first interface component is associated with the status trigger;
cause a user interface to be displayed, the user interface comprising the plurality of interface components; and
cause the first interface component of the plurality of interface components to be updated based at least in part on the status trigger.

12. The apparatus of claim 11, wherein the plurality of interface components are arranged on the user interface in a first interface configuration of a plurality of interface configurations.

13. The apparatus of claim 12, wherein the first interface configuration is based at least in part on a user type.

14. The apparatus of claim 12, wherein the first interface configuration is based at least in part on the first computing instance.

15. The apparatus of claim 11, wherein the plurality of computing instances comprises at least one of a reconditioning computing instance, an import computing instance, a product quality review computing instance, a group print computing instance, an insights computing instance, a machine learning computing instance, or a fabric computing instance.

16. The apparatus of claim 11, wherein the plurality of status triggers comprises at least one of a restart status trigger, a memory status trigger, a processing power status trigger, a workflow request status trigger, a workflow success status trigger, a workflow failure status trigger, or a workflow time status trigger.

17. The apparatus of claim 11, wherein the plurality of interface components comprises at least one of a restart interface component, a memory interface component, a processing power interface component, a workflow request interface component, a workflow success interface component, a workflow failure interface component, or a workflow time interface component.

18. The apparatus of claim 11, wherein the at least one processor is configured to:
determine that the first computing instance of the plurality of computing instances has been updated; and
generate an updated configuration specification based at least in part on the determination that the first computing instance has been updated.

19. The apparatus of claim 11, wherein the configuration specification identifies one or more workflows performed by the first computing instance of the plurality of computing instances.

20. A non-transitory computer-readable storage medium comprising computer program code for execution by one or more processors of a device, the computer program code configured to, when executed by the one or more processors, cause the device to:
generate a configuration specification, wherein the configuration specification is associated with a plurality of computing instances;
receive a status trigger from one of the plurality of computing instances, wherein the status trigger is one of a plurality of status triggers;
parse the configuration specification to determine that the status trigger was received from a first computing instance of the plurality of computing instances;
parse the configuration specification to determine a first interface component of a plurality of interface components associated with the plurality of status trigger, wherein the first interface component is associated with the status trigger;
cause a user interface to be displayed, the user interface comprising the plurality of interface components; and
cause the first interface component of the plurality of interface components to be updated based at least in part on the status trigger.
